(19) United States
(12) Patent Application Publication
(10) Pub. No.: US 2025/0164903 A1
(43) Pub. Date: May 22, 2025

(54) IMAGE FORMING APPARATUS

(71) Applicant: TOSHIBA TEC KABUSHIKI KAISHA, Tokyo (JP)

(72) Inventor: Taichi Suehiro, Mishima Shizuoka (JP)

(21) Appl. No.: 18/668,281

(22) Filed: May 20, 2024

(30) Foreign Application Priority Data
Nov. 21, 2023 (JP) 2023-197636

(51) Int. Cl. G03G 15/04; B41J 2/47; B41J 29/377; G03G 15/043; G03G 21/20

(52) U.S. Cl. CPC G03G 15/04036; B41J 2/471; B41J 29/377; G03G 15/0435; G03G 21/206

(57) ABSTRACT

An image forming apparatus includes: an exposure device; a housing including a support member that supports the exposure device; and a cooling device configured to make a refrigerant flow in a first direction in a space between the exposure device and the support member. The exposure device includes a first foot portion and a second foot portion aligned in the first direction and each protruding downward. The support member includes, on a surface thereof facing a lower surface of the exposure device, a first projection portion extending in a second direction intersecting the first direction and aligned with the first foot portion in the second direction, and a second projection portion extending in the second direction, aligned with the second foot portion in the second direction, and having a plurality of portions spaced apart from each other in the second direction. The first foot portion and the second foot portion are separated from the support member.

### CROSS-REFERENCE TO RELATED APPLICATION

This application is based upon and claims the benefit of priority from Japanese Patent Application No. 2023-197636, filed on Nov. 21, 2023, the entire contents of which are incorporated herein by reference.

### FIELD

An exemplary embodiment described herein relates generally to an image forming apparatus such as a copier or a printer installed in a work place.

### BACKGROUND

An image forming apparatus such as a copier and a printer includes an exposure device. The exposure device forms an electrostatic latent image on a surface of a photoconductor drum by exposing and scanning the surface of the photoconductor drum with a light beam emitted to the surface of the photoconductor drum. As a configuration for performing scanning with the light beam, for example, a polygon mirror and a polygon motor for driving the polygon mirror are provided inside the exposure device.

There is a method of reducing heat generation of a polygon motor by cooling an exposure device with cooling air. For example, there is an image forming apparatus in which a cooling air passage is formed between an exposure device and an attachment base of the exposure device.

On the other hand, the image forming apparatus is required to have high manufacturability during assembly in a factory. Therefore, a guide function for stably inserting the exposure device into a housing may be mounted on the attachment base.

However, the guide function is located between the exposure device and the attachment base. Therefore, the presence of the guide function restricts the cooling air passage, which may reduce a cooling function of the exposure device.

### DESCRIPTION OF THE DRAWINGS

FIG. 1 is a schematic diagram showing an image forming apparatus according to an embodiment;

FIG. 2 is a schematic diagram showing an image forming unit for yellow;

FIG. 3 is a perspective view showing an exposure device and a part of a housing;

FIG. 4 is a perspective view showing a part of the housing;

FIG. 5 is a plan view showing a support base and a support stay of the housing in FIG. 4;

FIG. 6 is a cross-sectional view of a part of the housing cut along line VI-VI in FIG. 5; and

FIG. 7 is a cross-sectional view of a part of the housing cut along line VII-VII in FIG. 5.

### DETAILED DESCRIPTION

In general, according to one embodiment, an image forming apparatus that reduces heat generation of an exposure device while ensuring high manufacturability is provided.

An image forming apparatus according to an embodiment includes: an exposure device; a housing including a support member that supports the exposure device; and a cooling device configured to make a refrigerant flow in a first direction in a space between the exposure device and the support member. The exposure device includes a first foot portion and a second foot portion aligned in the first direction and each protruding downward. The support member includes, on a surface thereof facing a lower surface of the exposure device, a first projection portion and a second projection portion. The first projection portion extends in a second direction intersecting the first direction and is aligned with the first foot portion in the second direction. The second projection portion extends in the second direction, is aligned with the second foot portion in the second direction, and has a plurality of portions spaced apart from each other in the second direction. The first foot portion and the second foot portion are separated from the support member.

Hereinafter, an image forming apparatus 100 according to an embodiment will be described with reference to the drawings. In the drawings to be used in the following description of the embodiment, a scale of each part may be appropriately changed. Further, in the drawings to be used in the following description of the embodiment, in order to make the description easy to understand, configurations may be omitted.

### Overall Configuration of Image Forming Apparatus 100

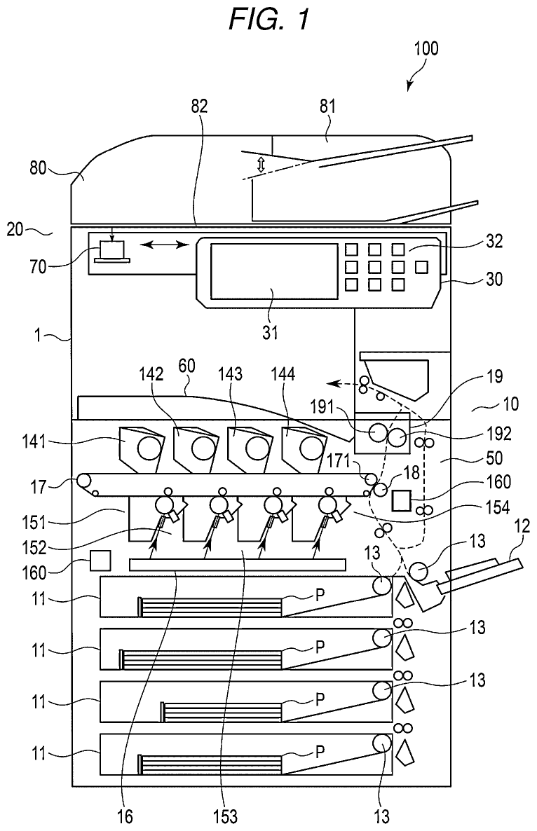

First, an overall configuration of the image forming apparatus 100 according to the embodiment will be described. FIG. 1 is a schematic diagram showing the image forming apparatus 100 according to the embodiment.

In the following description, a front-rear direction, an up-down direction, and a left-right direction of the image forming apparatus 100 viewed from a direction in FIG. 1 are defined. A surface including the front-rear direction and the left-right direction is, for example, substantially horizontal to a surface on which the image forming apparatus 100 is placed. The up-down direction is, for example, substantially perpendicular to the surface on which the image forming apparatus 100 is placed. The front-rear direction is an example of a first direction. The left-right direction is an example of a second direction. The up-down direction is an example of a third direction.

The image forming apparatus 100 is, for example, a multifunction peripheral (MFP). The image forming apparatus 100 has a printing function, a scanning function, a copying function, a decoloring function, a facsimile function, and the like. The printing function is a function of forming an image on a sheet P. The scanning function is a function of reading an image from a document or the like in which the image is formed. The copying function is, for example, a function of printing, the image read from the document or the like by using the scanning function, on the sheet P by using the printing function. The decoloring function is a function of decoloring the image formed on the sheet P with a decolorable developer. The facsimile function is a function of converting the image read from the document or the like by using the scanning function into an electric signal and transmitting the electric signal to another apparatus.

The image forming apparatus 100 includes a housing 1 that forms an outer shell of the apparatus. The image forming apparatus 100 includes a printer 10, a scanner 20, and an operation panel 30. The image forming apparatus 100 includes the printer 10 and the scanner 20 inside the housing 1, and includes the operation panel 30 on a front surface side in the housing 1.

The printer 10 includes a plurality of sheet feeding cassettes 11, a manual feed tray 12, and a plurality of sheet feeding rollers 13. The sheet feeding cassette 11 contains sheets P to be used for printing. The manual feed tray 12 is for manually feeding the sheet P. The sheet feeding roller 13 selectively picks up the sheet P from either the sheet feeding cassette 11 or the manual feed tray 12 by rotating.

The printer 10 includes four toner cartridges 141, 142, 143, and 144, four image forming units 151, 152, 153, and 154, an exposure device 16, a cooling device 160, a transfer belt 17, a secondary transfer roller 18, and a fixing unit 19. The printer 10 includes the exposure device 16 below the four image forming units 151, 152, 153, and 154.

The toner cartridges 141 to 144 contain toners to be supplied to the image forming units 151 to 154, respectively. The toner cartridge 141 contains a yellow (Y) toner. The toner cartridge 142 contains a magenta (M) toner. The toner cartridge 143 contains a cyan (C) toner. The toner cartridge 144 contains a black (K) toner. The toner color combination is not limited to YMCK, and may be any other color combination. Further, the toner may be a toner that is decolored at a temperature higher than a predetermined temperature.

The image forming units 151 to 154 are supplied with toners from the toner cartridges 141 to 144, respectively, and form toner images of different colors. The image forming unit 151 forms a yellow (Y) toner image. The image forming unit 152 forms a magenta (M) toner image. The image forming unit 153 forms a cyan (C) toner image. The image forming unit 154 forms a black (K) toner image.

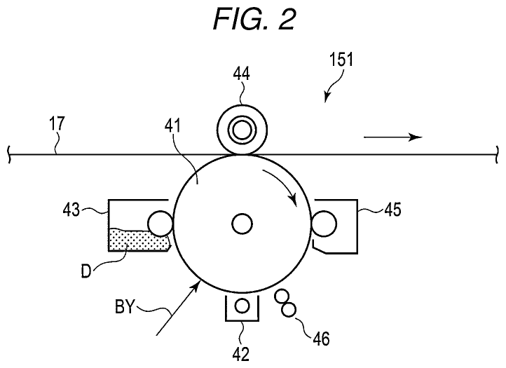

The image forming units 151 to 154 have the same configuration except for a difference in toner. Therefore, with reference to FIG. 2, the image forming unit 151 for yellow will be described as a representative, and the description of the image forming units 152 to 154 for other colors will be omitted.

FIG. 2 is a schematic diagram showing the image forming unit 151 for yellow of the image forming apparatus 100 in FIG. 1. The image forming unit 151 for yellow includes a photoconductor drum 41, a charging device 42, a developing device 43, a primary transfer roller 44, a cleaner 45, and a static elimination lamp 46.

The photoconductor drum 41 has a surface that receives a light beam BY emitted from the exposure device 16. The exposure device 16 forms an electrostatic latent image on the surface of the photoconductor drum 41. The charging device 42 charges the surface of the photoconductor drum 41 with positive charges. The developing device 43 develops the electrostatic latent on the the image surface of photoconductor drum 41 using a yellow toner D to be supplied from the toner cartridge 141. That is, the developing device 43 forms a yellow toner image on the surface of the photoconductor drum 41.

The image forming unit 151 includes the primary transfer roller 44 at a position facing the photoconductor drum 41 with the transfer belt 17 interposed therebetween. The primary transfer roller 44 generates a transfer voltage with the photoconductor drum 41. Accordingly, the primary transfer roller 44 transfers (primarily transfers) the toner image on the surface of the photoconductor drum 41 to a surface of the transfer belt 17 in contact with the photoconductor drum 41.

The cleaner 45 removes the toner remaining on the surface of the photoconductor drum 41. The static elimination lamp 46 eliminates charges remaining on the surface of the photoconductor drum 41.

The overall configuration of the image forming apparatus 100 will be described with reference to FIG. 1 again.

The exposure device 16 irradiates surfaces of the photoconductor drums 41 of the image forming units 151, 152, 153, and 154 with light beams BY, BM, BC, and BK, respectively, according to image data to be input. Specifically, the exposure device 16 includes a polygon mirror and a motor that rotates the polygon mirror therein. The exposure device 16 scans and exposes the surfaces of the photoconductor drums 41 of the image forming units 152, 153, and 154 with the light beams BY, BM, BC, and BK, respectively, by reflecting the light beams BY, BM, BC, and BK on the rotating polygon mirror. The light beams BY, BM, BC, and BK are based on image data of respective colors obtained by color-separating the image data into Y, M, C, and K colors. The exposure device 16 emits the light beam BY according to image data of a Y component, and forms an electrostatic latent image for yellow on the surface of the photoconductor drum 41 of the image forming unit 151. Similarly, the exposure device 16 emits the light beams BM, BC, and BK according to image data of M, C, and K components, and forms electrostatic latent images for the respective colors on the surfaces of the photoconductor drums 41 of the image forming units 152, 153, and 154.

The image data to be input to the exposure device 16 is, for example, image data read from a document or the like by the scanner 20. Alternatively, the image data to be input to the exposure device 16 is image data transmitted from an apparatus different from the image forming apparatus 100 to the image forming apparatus 100.

The cooling device 160 includes, for example, a fan. The fan of the cooling device 160 is located, for example, on a right side in the image forming apparatus 100. The cooling device 160 sends air generated by the fan below the exposure device 16 through a duct and cools the exposure device 16.

The transfer belt 17 is stretched in an endless shape, and is rotated by rotating a driving roller 171 around which the transfer belt 17 is wound. The transfer belt 17, by being rotated, conveys the toner images of the respective colors formed in an overlapping manner on the surface of the transfer belt 17 by the image forming units 151 to 154 to a transfer region faced by the secondary transfer roller 18.

The secondary transfer roller 18 faces the driving roller 171 with the transfer belt 17 sandwiched therebetween.

The secondary transfer roller 18 transfers (secondarily transfers) a toner image formed on the transfer belt 17 to the sheet P that passes between the secondary transfer roller 18 and the driving roller 171.

The fixing unit 19 heats and pressurizes the sheet P. The fixing unit 19 includes a heating roller 191 and a pressurizing roller 192 that face each other with a conveyance path of the sheet P sandwiched therebetween. The heating roller 191 includes a heat source such as a heater. The heating roller 191 heated by the heat source comes into contact with the sheet P to heat the sheet P. The pressurizing roller 192 pressurizes the sheet P that passes between the pressurizing roller 192 and the heating roller 191. Therefore, the fixing unit 19 fixes a toner image transferred to the sheet P onto the sheet P.

The printer 10 further includes a duplex unit 50 and a discharge tray 60. The duplex unit 50 brings the sheet P into a state in which printing on a back surface is possible. The duplex unit 50 reverses a front side and a back side of the sheet P by switching back the sheet P, and feeds the sheet P to the transfer region between the transfer belt 17 and the secondary transfer roller 18. The discharge tray 60 is for discharging the sheet P whose printing is ended.

The scanner 20 reads an image from a document or the like. The scanner 20 includes a reading module 70 and a document feeder 80.

The reading module 70 applies illumination light to a surface of a document including an image to be read (hereinafter, referred to as a document surface), receives reflected light thereof by an image sensor (not shown), and converts the received reflected light into a digital signal. Accordingly, the reading module 70 reads the image from the document surface.

The document feeder 80 is, for example, an auto document feeder (ADF). The document feeder 80 sequentially conveys documents placed on a document tray 81 through a document glass 82. The reading module 70 reads an image from a document conveyed to the document glass 82. The document feeder 80 may include another reading module for reading an image from a back surface of a document.

The operation panel 30 is a man-machine interface that performs input and output between the image forming apparatus 100 and an operator of the image forming apparatus 100. The operation panel 30 includes, for example, a touch panel 31 and an input device 32.

The touch panel 31 is formed by, for example, stacking a display such as a liquid crystal display or an organic EL display and a pointing device based on touch input. The display of the touch panel 31 displays a screen for notifying the operator of the image forming apparatus 100 of various kinds of information. Further, the touch panel 31 receives a touch operation performed by the operator.

The input device 32 receives an operation performed by the operator of the image forming apparatus 100. The input device 32 is, for example, a keyboard, a keypad, or a touch pad.

### Overview of Structure of Housing 1

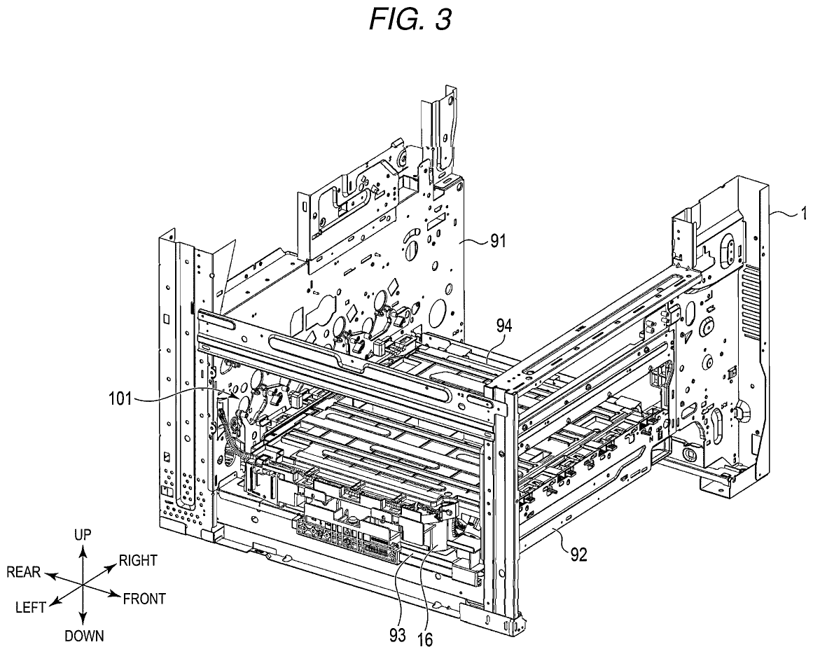

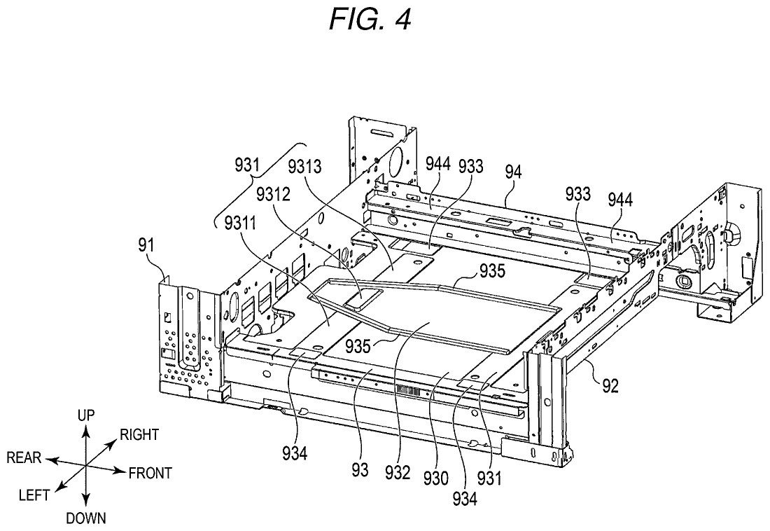

Next, an overview of a structure of the housing 1 will be described with reference to FIGS. 3 and 4.

FIG. 3 is a perspective view showing the exposure device 16 and a part of the housing 1 of the image forming apparatus 100 in FIG. 1. FIG. 4 is a perspective view showing a part of the housing 1 of the image forming apparatus 100 in FIG. 1. FIG. 3 shows the exposure device 16 and the housing 1 with the image forming units 151 to 154 and toner cartridges 141 to 144 located above the exposure device 16 removed. FIG. 4 shows the housing 1 in a state in which the exposure device 16 is further removed from FIG. 3.

The housing 1 includes a rear frame 91, a front frame 92, a support base 93, and a support stay 94 as a configuration for incorporating the exposure device 16. Further, the housing 1 has, on a left side surface thereof, an insertion opening 101 for inserting and attaching the exposure device 16 into the housing 1.

The rear frame 91 is a member formed of a sheet metal extending in the up-down direction and the left-right direction. The rear frame 91 is located on a back surface side of the image forming apparatus 100, that is, behind the exposure device 16. The cooling device 160 is provided on a back surface side of the rear frame 91. The cooling device 160 suctions air from a space between the support base 93 and the exposure device 16.

The front frame 92 is a member formed of a sheet metal extending in the up-down direction and the left-right direction. The front frame 92 is located on a front surface side of the image forming apparatus 100, that is, in front of the exposure device 16, and is substantially parallel to the rear frame 91. The front frame 92 includes a duct (not shown) behind the front frame 92 and between the front frame 92 and the exposure device 16. The duct functions as a flow path through which outside air is sent into the space between the support base 93 and the exposure device 16 according to the suction of the air from the space by the cooling device 160.

The support base 93 is a flat plate-shaped member formed of a sheet metal extending in the front-rear direction and the left-right direction. The support base 93 is slightly shorter than the exposure device 16 in the left-right direction and wider than a lower surface of the exposure device 16. The support base 93 is disposed substantially horizontally below the exposure device 16 and supports the exposure device 16. The support base 93 has a rear end fixed to a front surface of the rear frame 91 and a front end fixed to a rear surface of the front frame 92. The support base 93 is fixed to the rear frame 91 and the front frame 92 by, for example, welding. The support base 93 is an example of a support member.

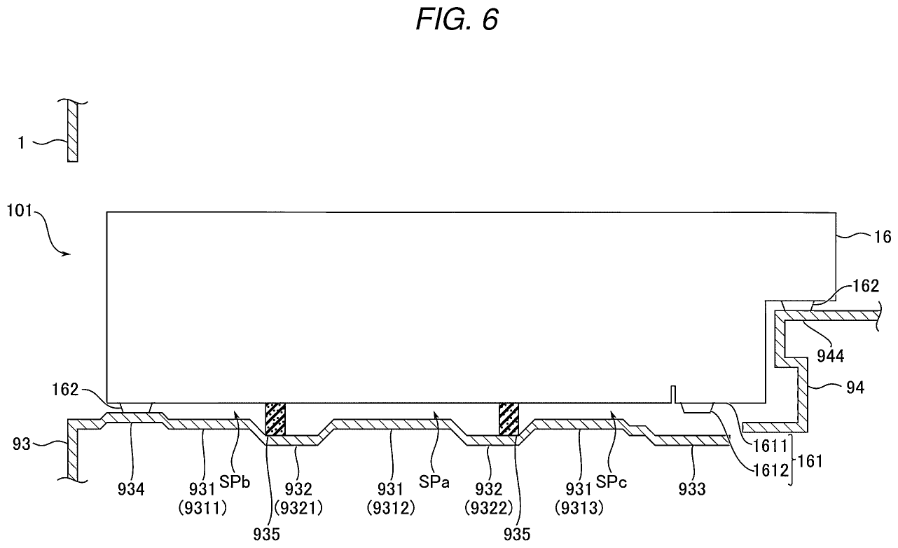

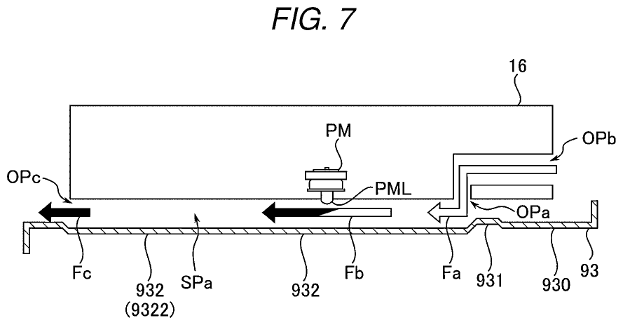

The support base 93 includes a rail that functions as an insertion guide that is in sliding-contact with and guides a lower surface of an insertion foot portion 161 (FIG. 6) protruding from the lower surface of the exposure device 16 when the exposure device 16 is inserted into and attached to the housing 1 from the insertion opening 101 on a left side in the housing 1. In addition, the support base 93 forms a space SPa (FIG. 7) through which air for cooling a polygon motor PM (FIG. 7) in the exposure device 16 flows between the support base 93 and the lower surface of the exposure device 16.

The support stay 94 is a member formed of a sheet metal extending in the front-rear direction. The support stay 94 is located apart on a right side of the support base 93 and supports the exposure device 16 together with the support base 93. The support stay 94 has a rear end fixed to the front surface of the rear frame 91 and a front end fixed to the rear surface of the front frame 92. The support stay 94 is fixed to the rear frame 91 and the front frame 92 by, for example, welding.

In the present embodiment, a case in which there is a gap S between the support base 93 and the support stay 94, and the support base 93 and the support stay 94 are members different from each other will be described, and the present disclosure is not limited thereto. For example, the support base 93 and the support stay 94 may be an integral member.

### Details of Structure of Support Base 93

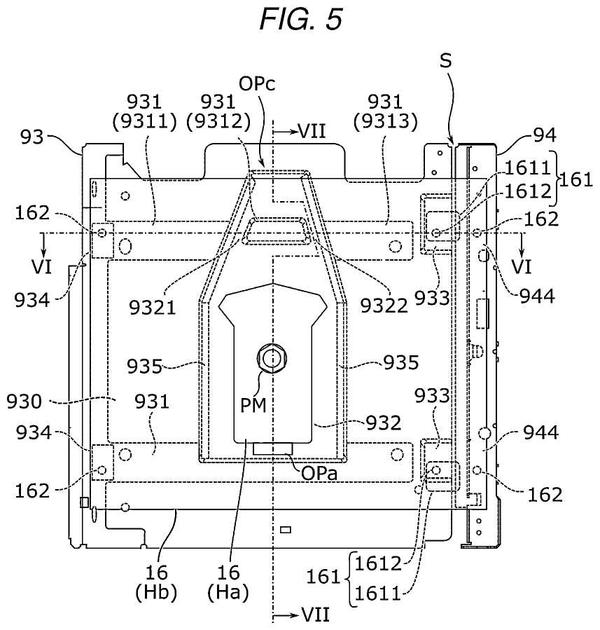

Next, a structure of the support base 93 will be described in detail with reference to FIGS. 5, 6, and 7.

FIG. 5 is a plan view showing the support base 93 and the support stay 94 of the housing 1 in FIG. 4. FIG. 6 is a cross-sectional view of a part of the housing 1 cut along line VI-VI in FIG. 5. FIG. 7 is a cross-sectional view of a part of the housing 1 cut along line VII-VII in FIG. 5. FIGS. 5, 6, and 7 show an outer edge of the exposure device 16, and the polygon mirror and the polygon motor PM which are internal configurations of the exposure device 16.

The exposure device 16 includes two insertion foot portions 161 and four support foot portions 162, each protruding from a lower surface side thereof. In addition, the exposure device 16 has an opening OPa on the lower surface and an opening OPb on a front side surface. The exposure device 16 has a space that passes through the inside thereof and connects the openings OPa and OPb.

The two insertion foot portions 161 have lower surfaces that are flat enough to be movable while being in contact with an upper surface of the support base 93 when the exposure device 16 is inserted into and attached to the housing 1 from the insertion opening 101. Each of the two insertion foot portions 161 includes a substantially rectangular portion 1611 and a substantially truncated conical portion 1612 protruding from a lower surface side of the portion 1611. The two insertion foot portions 161 are spaced apart from each other in the front-rear direction on a right side in the lower surface of the exposure device 16. The two insertion foot portions 161 are an example of a first foot portion and a second foot portion.

The four support foot portions 162 are located near four corners of the lower surface of the exposure device 16. Two of the four support foot portions 162 located on a left side are in contact with the upper surface of the support base 93 in a state in which the exposure device 16 is disposed at a predetermined position in the housing 1. Two of the four support foot portions 162 located on the right side are in contact with an upper surface of the support stay 94 in the state in which the exposure device 16 is disposed at the predetermined position in the housing 1. The four support foot portions 162 are an example of a plurality of third foot portions.

The support base 93 has a base portion 930, two projection portions 931, a recess portion 932, and two recess portions 933 on a surface (facing surface) facing the lower surface of the exposure device 16.

The base portion 930 is a main portion of the support base 93, and is a flat plate-shaped portion of a member constituting the support base 93.

The two projection portions 931 are portions that rise upward with respect to the base portion 930. The two projection portions 931 extend in the left-right direction at positions spaced apart from each other in the front-rear direction. Upper surfaces of the two projection portions 931 are located on substantially the same horizontal surface. That is, heights of the upper surfaces of the two projection portions 931 are substantially equal. The projection portion 931 located at the rear of the two projection portions 931 (hereinafter referred to as the rear projection portion 931) includes three portions 9311, 9312, and 9313 that are spaced apart from each other in the left-right direction. The three portions 9311, 9312, and 9313 are aligned in this order from the left side to the right side. The left and right two portions 9311 and 9313 are examples of a first portion. The central portion 9312 is an example of a second portion.

The support base 93 has two support regions 934 on the upper surface in a vicinity of a left end thereof. The support stay 94 has two support regions 944 on the upper surface thereof. The two support regions 934 support a total weight of the exposure device 16 together with the two support regions 944. Each of the support regions 934 and 944 is in contact with a lower surface of one corresponding support foot portion 162 among the four support foot portions 162 of the exposure device 16. An upper surface of each support region 934 is located at a higher position than the upper surface of the projection portion 931. An upper surface of each support region 944 is located at a higher position than the upper surface of the support region 934.

The recess portion 932 is a portion recessed downward with respect to the base portion 930. The recess portion 932 has, for example, a hexagonal shape when viewed from above, and is located at a position vertically overlapping the polygon motor PM in the exposure device 16. The lower surface of the exposure device 16 includes a sheet metal portion Ha located at a position vertically overlapping the recess portion 932 and supporting the polygon motor PM, and a resin portion Hb surrounding the sheet metal portion Ha. The sheet metal portion Ha of the lower surface of the exposure device 16 functions as a heat sink. The sheet metal portion Ha has a substantially circular hole, and a part of the polygon motor PM passes through the hole and reaches below the lower surface of the exposure device 16. That is, the polygon motor PM has a lower portion PML located closer to the support base 93 than the lower surface of the exposure device 16.

A front end of the recess portion 932 is located at a position overlapping the opening OPa provided on the lower surface of the exposure device 16 when viewed from above. A rear end of the recess portion 932 extends in the front-rear direction to reach a position behind the rear projection portion 931. Specifically, the recess portion 932 passes in the front-rear direction between the portions 9311 and 9313 of the rear projection portion 931. The portion 9312 of the rear projection portion 931 is located inside the recess portion 932. In other words, the recess portion 932 includes a groove portion 9321 located between the portions 9311 and 9312 of the rear projection portion 931 and a groove portion 9322 located between the portions 9312 and 9313. Lengths in the left-right direction of the groove portions 9321 and 9322 are smaller than a length in the left-right direction of the portion 1611 of the insertion foot portion 161.

A seal member 935 is provided inside the recess portion 932 so as to be in contact with two left side surfaces and two right side surfaces of six side surfaces forming a hexagonal shape. The seal member 935 has a width such that the groove portions 9321 and 9322 are not filled. The seal member 935 is, for example, a sponge-shaped low-repulsion elastic body. A length in the up-down direction of the seal member 935 is equal to or larger than a length from a bottom surface of the recess portion 932 to the lower surface of the exposure device 16. Accordingly, in a state in which the exposure device 16 is inserted into and disposed in the housing 1 (the state shown in FIG. 3), an upper end of the seal member 935 is in contact with the lower surface of the exposure device 16 in a state of being contracted by the exposure device 16. Therefore, the seal member 935 divides the space between the support base 93 and the exposure device 16 as well as the upper surface of the support base 93 and the lower surface of the exposure device 16 into a space SPa corresponding to the recess portion 932, a space SPb corresponding to a portion on a left side of the recess portion 932, and a space SPc corresponding to a portion on a right side of the recess portion 932.

In the present embodiment, a case in which a sponge-shaped elastic body is used as the seal member 935 has been described, and the present disclosure is not limited thereto. For example, as the seal member 935, any member such as a brush-shaped member or a sheet-shaped member that can reduce the inflow and outflow of air between the space SPa and the spaces SPb and SPc without interfering with the insertion of the exposure device 16 can be applied. In addition, in the present embodiment, a case in which no seal member 935 is provided on a front side surface of the recess portion 932 has been described, and the present disclosure is not limited thereto. For example, the seal member 935 may be provided on the front side surface of the recess portion 932 as long as the connection between the space SPa and the duct through the opening OPa is not obstructed.

The space SPa is connected to the duct (not shown) via the space in the exposure device 16 having the openings OPa and OPb as both ends in a front end thereof. The recess portion 932, the seal member 935, and the lower surface of the exposure device 16 form the opening OPc in rear ends thereof. The space SPa is connected to the cooling device 160 through the opening OPc. A length in the left-right direction of the front side surface of the recess portion 932 is sufficiently larger than a length in the left-right direction of the opening OPa. This is because the air flowing in from the opening OPa is supplied to the space SPa in a sufficient amount. In addition, a length in the left-right direction of a rear side surface of the recess portion 932 is equal to a length in the left-right direction of the opening OPC. This is because the air in the recess portion 932 is efficiently discharged from the space SPa by being guided to the opening OPc.

The two recess portions 933 are portions recessed downward with respect to the base portion 930. The two recess portions 933 are located near the gap S between the support stay 94 and the two projection portions 931 so as to be aligned with the two projection portions 931 in the left-right direction. The two recess portions 933 are located at positions facing the two insertion foot portions 161 in a state in which the exposure device 16 is inserted into and disposed in the housing 1 at the predetermined position. Bottom surfaces of the two recess portions 933 are located below the upper surfaces of the two projection portions 931. That is, in a state in which the exposure device 16 is disposed at the predetermined position in the housing 1 and the total weight of the exposure device 16 is supported by the four support foot portions 162, the two insertion foot portions 161 are separated from the bottom surfaces of the recess portions 933.

### Insertion Operation of Exposure Device 16

Next, an insertion operation for inserting the exposure device 16 from the insertion opening 101 into the inside of the housing 1 will be described. The insertion operation is performed by a worker, for example, when the image forming apparatus 100 is assembled in a factory.

When the worker inserts the exposure device 16 in a right direction from the insertion opening 101 on the left side in the housing 1, lower surfaces of the substantially truncated conical portions 1612 of the two insertion foot portions 161 aligned on a right side in the exposure device 16 are in sliding-contact with the upper surfaces of the two projection portions 931, respectively. Accordingly, the two projection portions 931 and both hands of the worker holding a left end of the exposure device 16 stably support the exposure device 16 at four points.

When the exposure device 16 is slid in the right direction, the substantially truncated conical portion 1612 of the insertion foot portion 161 located at the rear of the two insertion foot portions 161 (hereinafter, referred to as the rear insertion foot portion 161) is separated from the support base 93 by reaching the groove portion 9321. However, at this time, the substantially truncated conical portion 1612 of the insertion foot portion 161 located at the front of the two insertion foot portions 161 (hereinafter, referred to as the front insertion foot portion 161) is kept in contact with the projection portion 931 located at the front of the two projection portions 931 (hereinafter, referred to as the front projection portion 931). Therefore, the front projection portion 931 and both hands of the worker holding the left end of the exposure device 16 stably support the exposure device 16 at three points.

Subsequently, when the exposure device 16 is slid in the right direction, the substantially truncated conical portion 1612 of the rear insertion foot portion 161 is in sliding-contact with an upper surface of the central portion 9312 of the rear projection portion 931. Accordingly, the two projection portions 931 and both hands of the worker holding the left end of the exposure device 16 stably support the exposure device 16 at four points.

Subsequently, when the exposure device 16 is slid in the right direction, the substantially truncated conical portion 1612 of the rear insertion foot portion 161 is separated from the support base 93 by reaching the groove portion 9322. However, at this time, the substantially truncated conical portion 1612 of the front insertion foot portion 161 is kept in contact with the front projection portion 931. Therefore, the front projection portion 931 and both hands of the worker holding the left end of the exposure device 16 stably support the exposure device 16 at three points.

Subsequently, when the exposure device 16 is slid in the right direction, the substantially truncated conical portion 1612 of the rear insertion foot portion 161 is in sliding-contact with an upper surface of the right portion 9313 of the rear projection portion 931. Accordingly, the two projection portions 931 and both hands of the worker holding the left end of the exposure device 16 stably support the exposure device 16 at four points.

Subsequently, when the exposure device 16 is slid in the right direction, immediately before the exposure device 16 is pushed to a predetermined position, each of the two insertion foot portions 161 is deviated from the corresponding projection portion 931 and moves toward a position facing each of the two recess portions 933.

On the other hand, when each of the two insertion foot portions 161 is deviated from the corresponding projection portion 931, the two support foot portions 162 on the right side in the exposure device 16 are in contact with the upper surface of the support stay 94. When the exposure device 16 is further pushed to the predetermined position, lower surfaces of the two support foot portions 162 on the right side in the exposure device 16 overlap the support regions 944 of the support stay 94. Then, when the exposure device 16 is pushed to the predetermined position, each of the two insertion foot portions 161 of the exposure device 16 is in contact with the support region 944 of the support stay 94 instead of overlapping the corresponding recess portion 933 and floating from the support base 93. That is, the support stay 94 supports a part of the weight of the exposure device 16.

At this time, lower surfaces of the two support foot portions 162 on the left side in the exposure device 16 are in contact with the upper surfaces of the support regions 934 of the support base 93. Accordingly, the support base 93 supports the remaining weight of the exposure device 16. That is, in this state, substantially the entire weight of the exposure device 16 is supported by the upper surface of the support base 93 and the upper surface of the support stay 94 via the four support foot portions 162, and the exposure device 16 is not in contact with the support base 93 except for the support regions 934.

As described above, the length in the left-right direction of the substantially rectangular portion 1611 of the insertion foot portion 161 is larger than the lengths in the left-right direction of the groove portions 9321 and 9322. Accordingly, even if the exposure device 16 is tilted from the state of being supported at three points, the substantially rectangular portion 1611 of the insertion foot portion 161 is in contact with the rear projection portion 931 before the exposure device 16 is tilted to such an extent that the insertion of the exposure device 16 by the worker is obstructed. Therefore, it is possible to reduce deterioration of manufacturability in the insertion operation due to the presence of the groove portions 9321 and 9322.

### Cooling Operation of Exposure Device 16

Next, a cooling operation for cooling the exposure device 16 will be described. The cooling operation is performed by the cooling device 160, for example, when the exposure device 16 operates, particularly when the polygon motor PM generates heat.

The cooling device 160 suctions the air in the space SPa. As the air in the space SPa is exhausted, air (outside air) flows into the space SPa through the duct in front. The air flowing in through the duct has a lower temperature than the air in the space SPa. Accordingly, the cooling device 160 functions to make the air having a lower temperature to flow from the front to the rear in the space SPa.

As described above, the sheet metal portion Ha of the lower surface of the exposure device 16 supports the polygon motor PM and is in contact with the air in the space SPa. Accordingly, the polygon motor PM can exchange heat with the air in the space SPa via the sheet metal portion Ha. Therefore, the cooling device 160 functions to supply cold air from the opening OPa (flow path Fa in FIG. 7), cool the polygon motor PM by the cold air (flow path Fb in FIG. 7), and discharge warm air that absorbs heat from the polygon motor PM from the opening OPc (flow path Fc in FIG. 7). That is, the air flowing in the space SPa can function as a refrigerant that continuously absorbs heat from the polygon motor PM when the polygon motor PM generates heat.

### Effects of Embodiment

According to the embodiment, the exposure device 16 includes the two insertion foot portions 161 aligned in the front-rear direction and each protruding downward. The support base 93 includes, on the surface thereof facing the lower surface of the exposure device 16, the front projection portion 931 extending in the left-right direction and aligned with the front insertion foot portion 161 in the front-rear direction, and the rear projection portion 931 extending in the left-right direction and aligned with the rear insertion foot portion 161 in the front-rear direction. Accordingly, in the insertion operation, the worker can slide the exposure device 16 from left to right while bringing the two insertion foot portions 161 into contact with the upper surfaces of the two projection portions 931 in a state in which both hands hold the left side of the exposure device 16. In this way, by using the two projection portions 931 as insertion guides, the exposure device 16 can be smoothly inserted into the housing 1 at the predetermined position. Therefore, the manufacturability during assembly can be ensured.

The two insertion foot portions 161 are separated from the support base 93 in the state in which the exposure device 16 is inserted into and disposed in the housing 1 at the predetermined position. Accordingly, in the state in which the exposure device 16 is inserted into and disposed in the housing 1 at the predetermined position, the exposure device 16 is not in contact with the support base 93 except for the support regions 934. Therefore, even when the support base 93 vibrates, the vibration is less likely to be transmitted to the exposure device 16. Therefore, it is possible to prevent a quality of the image to be output by the image forming apparatus 100 from being deteriorated due to a structure used for the insertion operation of the exposure device 16.

The rear projection portion 931 has a plurality of portions 9311, 9312, and 9313 spaced apart from each other in the front-rear direction. Accordingly, the recess portion 932 includes the groove portions 9321 and 9322 extending in the front-rear direction between the left portion 9311 and the central portion 9312 and between the central portion 9312 and the right portion 9313 of the rear projection portion 931. Therefore, when air flows from the front to the rear between the exposure device 16 and the support base 93 by the cooling device 160, it is possible to reduce an influence of the rear projection portion 931 obstructing the flow of air. Therefore, the air flowing from the front to the rear by the cooling device 160 can efficiently function as a refrigerant.

The substantially rectangular portion 1611 of the rear insertion foot portion 161 has a larger length than each of the groove portions 9321 and 9322 in the left-right direction. Accordingly, in the insertion operation, when the substantially truncated conical portion 1612 of the rear insertion foot portion 161 is at a position facing the groove portion 9321 or 9322, even if the exposure device 16 is tilted, it is possible to prevent an increase in the tilt of the exposure device 16. Therefore, the rear projection portion 931 has the plurality of portions 9311, 9312, and 9313, whereby it is possible to prevent a decrease in manufacturability during assembly.

The support base 93 includes the recess portion 932 extending in the front-rear direction so as to intersect the rear projection portion 931 at a position overlapping the polygon motor PM when viewed from above. Accordingly, the amount of air flowing between the exposure device 16 and the support base 93 can be increased. Therefore, it is possible to increase the amount of air that absorbs the heat from the polygon motor PM. Therefore, a cooling function of the polygon motor PM by the cooling device 160 can be improved.

The seal member 935 is provided inside the recess portion 932 so as to be in contact with the side surface thereof. Accordingly, the space between the exposure device 16 and the support base 93 can be divided into the three spaces SPa, SPb, and SPc without obstructing the insertion operation. Therefore, warm air warmed by the polygon motor PM leaks into the spaces SPb and SPc, and thus it is possible to present components fixing a mirror other than the polygon mirror in the exposure device 16 from being deformed due to the warm air. Therefore, it is possible to prevent the mirror from unintentionally moving from a predetermined position due to the deformation of a component, and to prevent the quality of the image to be output by the image forming apparatus 100 from being deteriorated.

The upper end of the seal member 935 is in contact with the lower surface of the exposure device 16 in the state in which the exposure device 16 is inserted into and disposed in the housing 1 at the predetermined position. Accordingly, it is possible to further prevent the inflow and outflow of air between the space SPa and the spaces SPb and SPc. Therefore, the cooling function of the polygon motor PM by the cooling device 160 can be improved.

The sheet metal portion Ha of the lower surface of the exposure device 16 is in contact with the space SPa. Accordingly, in the cooling operation, the polygon motor PM can continuously release heat to the cold air in the space SPa via the sheet metal portion Ha. Therefore, the sheet metal portion Ha can function as the heat sink, and the cooling device 160 can more efficiently absorb the heat from the polygon motor PM.

While an exemplary embodiment has been described, the embodiment has been presented by way of example and is not intended to limit the scope of the disclosure. The embodiment can be implemented in various other forms, and various omissions, substitutions, and changes can be made in a scope not departing from the gist of the disclosure. The embodiment and modifications thereof are included in the scope and the gist of the disclosure, and are included in a scope of the disclosure disclosed in the claims and equivalents thereof.

Hereinafter, other embodiments will be additionally described.

### Appendix 1

An image forming apparatus including:
an exposure device;
a housing including a support member that supports the exposure device; and
a cooling device configured to make a refrigerant flow in a first direction in a space between the exposure device and the support member, in which
the exposure device includes a first foot portion and a second foot portion aligned in the first direction and each protruding downward,
the support member includes, on a surface thereof facing a lower surface of the exposure device, a first projection portion extending in a second direction intersecting the first direction and aligned with the first foot portion in the second direction, a second projection portion extending in the second direction, aligned with the second foot portion in the second direction, and divided into a plurality of portion in the second direction, and
the first foot portion and the second foot portion are separated from the support member.

### Appendix 2

The image forming apparatus according to Appendix 1, in which
the support member further includes, on the facing surface, a recess portion extending in the first direction so as to intersect the second projection portion.

### Appendix 3

The image forming apparatus according to Appendix 1, in which
the exposure device further includes a plurality of third foot portions protruding downward separately from the first foot portion and the second foot portion, and
the support member is in contact with lower surfaces of the plurality of third foot portions and supports the exposure device.

### Appendix 4

The image forming apparatus according to Appendix 1, in which
an upper surface of the first projection portion and an upper surface of the second projection portion are located on substantially the same horizontal surface.

### Appendix 5

The image forming apparatus according to Appendix 2, in which
the plurality of portions include a first portion located outside the recess portion and a second portion located inside the recess portion, and
the recess portion includes a groove portion located between the first portion and the second portion.

### Appendix 6

The image forming apparatus according to Appendix 5, in which
the second foot portion has a larger length than the groove portion in the second direction.

### Appendix 7

The image forming apparatus according to Appendix 2, in which
the exposure device includes a polygon mirror and a polygon motor configured to drive the polygon mirror,
the polygon motor overlaps the recess portion when viewed from a third direction intersecting the first direction and the second direction.

### Appendix 8

The image forming apparatus according to Appendix 7, in which
a lower portion of the polygon motor is located in the space.

What is claimed is:

1. An image forming apparatus, comprising:
an exposure device;
a housing including a support member that supports the exposure device; and
a cooling device configured to facilitate a refrigerant flow in a first direction in a space between the exposure device and the support member, wherein
the exposure device includes a first foot portion and a second foot portion aligned in the first direction and each protruding downward,
the support member includes, on a surface thereof facing a lower surface of the exposure device, a first projection portion extending in a second direction intersecting the first direction and aligned with the first foot portion in the second direction, and a second projection portion extending in the second direction, aligned with the second foot portion in the second direction, and including a plurality of portions spaced apart from each other in the second direction, and
the first foot portion and the second foot portion are separated from the support member.

2. The image forming apparatus according to claim 1, wherein
the support member further includes, on the surface facing lower surface of the exposure device, a recess portion extending in the first direction so as to intersect the second projection portion.

3. The image forming apparatus according to claim 2, further comprising
a seal member provided on a side surface of the recess portion.

4. The image forming apparatus according to claim 3, wherein
an upper end of the seal member is in contact with a lower surface of the exposure device.

5. The image forming apparatus according to claim 1, wherein
the housing includes, on a side surface thereof, an insertion opening for inserting and attaching the exposure device, and
the support member is a plate-shaped member disposed substantially horizontally adjacent to the insertion opening, and the support member configured to act as an insertion guide that guides the insertion of the exposure device by making the second foot portion in sliding-contact with the second projection portion while making the first foot portion in sliding-contact with the first projection portion when the exposure device is inserted into and attached to the housing in the second direction through the insertion opening.

6. The image forming apparatus according to claim 1, wherein
the cooling device comprises a fan configured to send air below the exposure device through a duct.

7. The image forming apparatus according to claim 1, wherein
the support member has a flat plate-shaped member formed of a sheet metal extending in the front-rear direction and the left-right direction, and the support member is shorter than the exposure device in the left-right direction and wider than a lower surface of the exposure device.

8. The image forming apparatus according to claim 1, wherein
the support member is disposed substantially horizontally below the exposure device.

9. The image forming apparatus according to claim 1, wherein
the support member comprises a rail in sliding-contact with a lower surface of an insertion foot portion protruding from the lower surface of the exposure device when the exposure device is inserted into and attached to the housing.

10. The image forming apparatus according to claim 1, wherein
the support member partially forms a space through which air for cooling a polygon motor in the exposure device flows between the support member and a lower surface of the exposure device.

11. A multifunction peripheral, comprising:
a printer component;
a scanning component;
a copy component;
an exposure device;
a housing including a support member that supports the exposure device; and
a cooling device configured to facilitate a refrigerant flow in a first direction in a space between the exposure device and the support member, wherein
the exposure device includes a first foot portion and a second foot portion aligned in the first direction and each protruding downward,
the support member includes, on a surface thereof facing a lower surface of the exposure device, a first projection portion extending in a second direction intersecting the first direction and aligned with the first foot portion in the second direction, and a second projection portion extending in the second direction, aligned with the second foot portion in the second direction, and including a plurality of portions spaced apart from each other in the second direction, and
the first foot portion and the second foot portion are separated from the support member.

12. The multifunction peripheral according to claim 11, wherein
the support member further includes, on the surface facing lower surface of the exposure device, a recess portion extending in the first direction so as to intersect the second projection portion.

13. The multifunction peripheral according to claim 12, further comprising
a seal member provided on a side surface of the recess portion.

14. The multifunction peripheral according to claim 13, wherein
an upper end of the seal member is in contact with a lower surface of the exposure device.

15. The multifunction peripheral according to claim 11, wherein
the housing includes, on a side surface thereof, an insertion opening for inserting and attaching the exposure device, and
the support member is a plate-shaped member disposed substantially horizontally adjacent to the insertion opening, and the support member configured to act as an insertion guide that guides the insertion of the exposure device by making the second foot portion in sliding-contact with the second projection portion while making the first foot portion in sliding-contact with the first projection portion when the exposure device is inserted into and attached to the housing in the second direction through the insertion opening.

16. The multifunction peripheral according to claim 11, wherein
the cooling device comprises a fan configured to send air below the exposure device through a duct.

17. The multifunction peripheral according to claim 11, wherein
the support member has a flat plate-shaped member formed of a sheet metal extending in the front-rear direction and the left-right direction, and the support member is shorter than the exposure device in the left-right direction and wider than a lower surface of the exposure device.

18. The multifunction peripheral according to claim 11, wherein
the support member is disposed substantially horizontally below the exposure device.

19. The multifunction peripheral according to claim 11, wherein
the support member comprises a rail in sliding-contact with a lower surface of an insertion foot portion protruding from the lower surface of the exposure device when the exposure device is inserted into and attached to the housing.

20. The multifunction peripheral according to claim 11, wherein
the support member partially forms a space through which air for cooling a polygon motor in the exposure device flows between the support member and a lower surface of the exposure device.
